(19) United States
(12) Patent Application Publication
(10) Pub. No.: US 2019/0333338 A1
(43) Pub. Date: Oct. 31, 2019

(54) System for Games of Skill Based Upon Simulated Results of Events

(71) Applicant: Platform Gaming Technologies, Inc., Tampa, FL (US)

(72) Inventor: David Brian Hirsch, Tampa, FL (US)

(73) Assignee: Platform Gaming Technologies, Inc., Tampa, FL (US)

(21) Appl. No.: 16/393,492

(22) Filed: Apr. 24, 2019

Related U.S. Application Data
(60) Provisional application No. 62/662,617, filed on Apr. 25, 2018.

(51) Int. Cl. G07F 17/32

(52) U.S. Cl. CPC G07F 17/3288; G07F 17/3295; G07F 17/3272; G07F 17/3223

(57) ABSTRACT

A gaming system includes a server and a plurality of participant devices. Each participant device is associated with a participant. The server generates a random schedule of games then requests a first wager from each participant device. Each participant device makes a selection of a subset of players that are associated with each game of the schedule of games. Next, the server simulates an outcome of the random schedule of games and each selection of a subset of players is evaluated by the server to generate a score based upon the subset of players for each participant and a payout is made based upon each score.

### CROSS-REFERENCE TO RELATED APPLICATION

This application claims the benefit of U.S. provisional application No. 62/662,617 filed on Apr. 25, 2018, the disclosure of which is incorporated by reference.

### FIELD

This invention relates to the field of entertainment and education and more particularly to a system to administer a variety of games of skill that are based on the simulated results of a plurality events of a given subject matter, where the simulated results of the plurality of events use objective criteria based on the past results of historical real-world events of the same subject matter.

### BACKGROUND

Games of skill typically rely upon the knowledge and/or ability of the participants in determining the outcome. However, almost all games of skill possess some level of randomness or chance.

A game of skill depends, at least somewhat, upon each participant's skills, but being a game, there is still some level of randomness, otherwise, the most skillful participant will always win. Typically, operators of games of skill establish rules and scoring criteria that are fair with completely objective standards that are outside the control of the participants and the game operator.

Some games of skill are based on a participant's ability to predict the outcome of future real-world events. One example of a widely played game of skill of this type is fantasy sports. Millions of people participate in fantasy sports games each week. Before a real-world game starts, game operators typically require that participants enter selections for a fantasy team or “lineup”, which is composed of a set of athletes that fill various required positions. For example, in a fantasy games based on American football, a participant might be required to fill a roster that is comprised of one quarterback, two running backs, three wide receivers, a tight end and a kicker. Before the first scheduled underlying football game is played, admission of new participants is closed. The underlying real-world football games are then played, and the performance of the athletes is calculated. Athlete performance is typically based on a fantasy points scoring system where fantasy points are awarded based on a set of objective criteria. For example, in American football a quarterback might earn 250 fantasy points for accumulating 250 passing yards and another 60 points for scoring one passing touchdown during that week's game. Each participant would earn the cumulative fantasy points of the athletes in their lineup. Participants' final scores are then ranked, and payouts and/or prizes are awarded according to a pre-set scheme.

Games of skill, such as fantasy sports, that are based on a participant's ability to predict the outcome of future real-world events have certain limitations.

One of these limitations is the requirement that an underlying event or series of events be scheduled in the proximate future for a game to be played. For example, there can be no fantasy football games if there is no real-world football games scheduled in the proximate future.

What is needed are new game formats that utilize a method of simulation to enable game play during times when underlying real world events are not scheduled in the proximate future. For example, providing the ability to play fantasy football during the “off season” when no actual real-world football games are scheduled. Additionally, the method of simulation employed should produce results that are realistic and closely approximate the results that would have been produced in real life in terms of randomness the skill required of a game's participants such that it is still a factor in the determination of the ultimate outcome of the game.

Another limitation is the lengthy duration required to complete a game. For example, in a typical week of NFL football, games are played on Thursday night, all day on Sunday and on Monday night. As such, a fantasy football game based on one week of the NFL football takes several days to complete. Because of this lengthy duration, the game itself is often less exciting and enjoyable for participants. What is needed are new game formats that employ a method of simulation that produces output quickly and efficiently resulting in shorter game duration times, which will enhance participant experience and enjoyment.

Additionally, some games of skill have limitations in the number of participants who can play at any given time. This reduces the fun and excitement of the game. People are typically more likely to participate in games where their knowledge and skill gives them an edge in predicting the outcomes, especially when the winners of a particular game have paid an entry fee to participate and/or could win money based on the outcome.

It has been found that people are also more likely to participate in games where their ability to play is not restricted to certain seasons, days or times and they can play at their leisure when their own schedule permits.

People are also more likely to participate in a game where the game's duration is shorter in nature. In other words, when the time between a participant's placement of an entry and the revelation of the outcome takes less time. Additionally, people are more likely to participate in contests with more participants. This is especially true for games of skill that require an entry fee and offer a progressive prize pool because the potential for winning larger prizes increases with the number of entrants.

What is needed is a method of simulation coupled with game formats that will enable event-based types of games to include larger numbers of participants and be independent of actual real-world events.

### SUMMARY

Game formats can typically be broken down into three categories. One category is where participants play against each other in a tournament setting (a “tournament”). Another category is where participants play against the game operator (a “house Game”), and a third category is where pari-mutuel wagering is employed (a “pari-mutuel game”).

In one embodiment, a gaming system is disclosed including a server and a plurality of participant devices. Each participant device is associated with a participant. The server generates a random schedule of games then requests a first wager from each participant device. Each participant device makes a selection of a subset of players that are associated with each game of the schedule of games. Next, the server simulates an outcome of the random schedule of games and each selection of a subset of players is evaluated by the server to generate a score and a payout is made based upon each score.

In another embodiment, a method of gaming by a set of participants is disclosed including generating a random schedule of games and requesting a first wager from each participant. Next, a subset of players is received from each participant, the subset of players comprising players that will play in the games of the random schedule of games. Now, an outcome of each game of the random schedule of games is simulated and a fantasy score for each player of the players is generated based upon the outcome of each game. The players are sorted by the fantasy score of each player a score is generated for each participant based upon the subset of players from that participant and the fantasy score of each player in the subset of players from that participant.

In another embodiment, program instructions tangibly embodied in a non-transitory storage medium comprising at least one instruction configured to implement a system for gaming between a set of participants is disclosed in which at least one instruction includes computer readable instructions executed by a processor cause the system for gaming to generate a random schedule of games, each game having players. The computer readable instructions executed by the processor cause the system for gaming to request a first wager from each participant of the set of participants and to receive a subset of the players from each participant. Next, the computer readable instructions executed by the processor cause the system for gaming to simulate an outcome of each game of the random schedule of games. Next, the computer readable instructions executed by the processor cause the system for gaming to generate a fantasy score for each of the players based upon the outcome of each game and to sort the players by the fantasy score of each player. Next, the computer readable instructions executed by the processor cause the system for gaming to generate a score for each participant based upon the subset of players from that participant and the fantasy score of each player in the subset of players from that participant.

In one embodiment, a gaming system is disclosed including a server having a basket comprising a set of events and a simulation engine. There are several participant devices connected to the server. The participant devices accept participant selections with respect to a pre-determined game. Each participant selection is based on a pre-configured subset, where a subset contains one or more events. Participant selections are submitted, and the simulation engine randomly simulates results of the events in the basket based on their historical, statistical performance using objective criteria. The server has a way to determine the results of the events from the basket and the performance of each participant submitted subset based on objective criteria and the server has a way to determine the relative performance of the submitted subset of all users. Prizes are awarded to participants whose selected subsets produce the greatest relative performance.

In another embodiment, a gaming system is disclosed including a server having a basket comprising a set of events and a simulation engine. There are several participant devices connected to the server. The participant devices accept participant selections with respect to a pre-determined game. Each participant selection is based on a pre-configured subset, where a subset contains one or more events. Participant selections are submitted, and the simulation engine randomly simulates results of the events in the basket based on their historical, statistical performance using objective criteria. The results of the simulation are revealed sequentially in multiple stages and, either before or after each stage, participants must elect to either place an additional wager to remain in the game or fold and exit the game. After the final stage has been revealed and wagering has concluded, the server has a way to determine the results of the events from the basket and the performance of each participant submitted subset based on objective criteria and the server has a way to determine the relative performance of the submitted subset of all users. Prizes are awarded to participants whose selected subsets produce the greatest relative performance.

In another embodiment, a gaming system is disclosed including a server having a basket comprising a set of events and a simulation engine. There are several participant devices connected to the server. The participant devices accept participant selections with respect to a pre-determined game. Each participant selection is based on a pre-configured subset, where a subset contains one or more events. Participant selections are submitted, and the simulation engine randomly simulates results of the events in the basket based on their historical, statistical performance using objective criteria. Wagering and game flow is based on table or “poker” style wagering where the results of the simulation are revealed sequentially in stages. After the results of a given stage are revealed, individual participants place wagers sequentially in order where they may opt to check, bet, call, raise a prior participant's wager, or fold. After the results of the final stage are revealed and all wagering has been concluded, the server has a way to determine the results of the events from the basket and the performance of each participant submitted subset based on objective criteria and the server has a way to determine the relative performance of the submitted subset of all users. Prizes are awarded to participants whose selected subsets produce the greatest relative performance.

In another embodiment, a gaming system is disclosed including a server having a basket comprising a set of events and a simulation engine. There are several participant devices connected to the server. The participant devices accept participant selections with respect to a pre-determined game. Each participant selection is based on a pre-configured subset, where a subset contains one or more events. Participant selections are submitted, and the simulation engine randomly simulates results of the events in the basket based on their historical, statistical performance using objective criteria. Wagering and game flow is based on staged play, where the results of the simulation are revealed in stages. After each stage, participant selections are scored and their relative performance is calculated. Participants failing to meet a certain threshold score are ejected from the game and the remaining participants play in the next stage where they may then be required make additional selections from the plurality of events. The game continues through successive stages until either a single participant remains and is awarded a payout, or all contemplated stages have been completed. When this occurs, the server has a way to determine the results of the events from the basket and the performance of each participant submitted subset from the final stage, or cumulatively for all stages played, based on objective criteria and the server has a way to determine the relative performance of the submitted subset of all users. Prizes are awarded to participants whose selected subsets produce the greatest relative performance.

In another embodiment, a gaming system is disclosed including a server having a basket comprising a set of events and a simulation engine. There are several participant devices connected to the server. The participant devices accept participant selections with respect to a pre-determined game. The method for selection of a sub-set of the events in the basket by a participant is subject to certain rules or limitations to discourage or prevent players from selecting the same sub-set of events in the basket (i.e. a “salary cap”). Additionally, each participant selection is based on a pre-configured subset, where a subset contains one or more events. Participant selections are submitted, and the simulation engine randomly simulates results of the events in the basket based on their historical, statistical performance using objective criteria. The server has a way to determine the results of the events from the basket and the performance of each participant submitted subset based on objective criteria and the server has a way to determine the relative performance of the submitted subset of all users. Prizes are awarded to participants whose selected subsets produce the greatest relative performance.

In another embodiment, a gaming system is disclosed including a server having a basket comprising a set of events and a simulation engine. There are several participant devices connected to the server. The participant devices accept participant selections with respect to a pre-determined game. The method for selection of a sub-set of the events in the basket by a participant is subject to certain rules or limitations whereby a pre-set order for participants to make their selections is determined. The selection process then commences with each participant, one-at-a-time, selecting a single event from the basket, typically within a certain time frame. Once one participant has made their selection, they are followed by the next participant in the pre-set order until all required participant selections have been completed and the game continues (i.e. a “snake draft”). Once the process has concluded, the participant selections are submitted, and the simulation engine randomly simulates results of the events in the basket based on their historical, statistical performance using objective criteria. The server has a way to determine the results of the events from the basket and the performance of each participant submitted subset based on objective criteria and the server has a way to determine the relative performance of the submitted subset of all users. Prizes are awarded to participants whose selected subsets produce the greatest relative performance.

In another embodiment, a gaming system is disclosed including a server having a basket comprising a set of events (i.e. NBA basketball players) and a simulation engine. There are several participant devices connected to the server. The participant devices accept participant selections with respect to a pre-determined game (i.e. pick the five highest scoring basketball players for 15 games of simulated NBA basketball based on a randomly generated schedule). Each participant selection is based on a pre-configured subset, where a subset contains a subset of events in the basket (i.e. a lineup of five NBA basketball players). Participant selections are submitted, and the simulation engine randomly simulates results of the events in the basket based on their historical, statistical performance using objective criteria (the performance of all NBA players in the basket are simulated based on their historical, statistical performance, i.e. scoring, assists, rebounds, etc.). The server has a way to determine the results of the events from the basket and the performance of each participant submitted subset based on objective criteria and the server has a way to determine the relative performance of the submitted subset of all users (i.e. each participant's five-man lineup is scored using a fantasy points scoring system). Prizes are awarded to participants whose selected subsets produce the greatest relative performance.

In another embodiment, a gaming system is disclosed including a server having a basket comprising a set of events and a simulation engine. There are several participant devices connected to the server. The participant devices accept participant selections with respect to a pre-determined game. Each participant selection is based on a pre-configured subset, where a subset contains one or more events. The game operator manually selects or the server generates a selection based on a pre-configured subset of events in the basket to serve as a benchmark. Participant selections are submitted, and the simulation engine randomly simulates results of the events in the basket based on their historical, statistical performance using objective criteria. The server has a way to determine the results of the events from the basket and the performance of each participant submitted subset as well as the benchmark based on objective criteria. The server has a way to determine the relative performance of the submitted subset of all participants. The server also has a way to determine the relative performance of the submitted subset of all participants with the benchmark. Prizes are awarded to participants whose selected subsets beat the benchmark and/or produce the greatest relative performance.

In another embodiment, a gaming system is disclosed including a server having a basket comprising a set of events and a simulation engine. There are several participant devices connected to the server. The participant devices accept participant selections with respect to a pre-determined game where the objective of the game is to beat a designated celebrity (i.e. Michael Jordan). Each participant selection is based on a pre-configured subset, where a subset contains one or more events. The celebrity (Michael Jordan) submits his selections, also based on a pre-configured subset of events in the basket to serve as a benchmark. Participant selections are submitted, and the simulation engine randomly simulates results of the events in the basket based on their historical, statistical performance using objective criteria. The server has a way to determine the results of the events from the basket and the performance of each participant submitted subset as well as the celebrity's selections (i.e. Michael Jordan's picks) based on objective criteria. The server has a way to determine the relative performance of the submitted subset of all participants. The server also has a way to determine the relative performance of the submitted subset of all participants with the celebrity's selections (i.e. Michael Jordan's picks). Prizes are awarded to participants whose selected subsets beat the celebrity (Michael Jordan) and/or produce the greatest relative performance.

In another embodiment, a gaming system is disclosed including a server having a basket comprising a set of events (NBA basketball players) and a simulation engine. There are several participant devices connected to the server. The participant devices accept participant selections with respect to a pre-determined game (i.e. pick the five highest scoring basketball players for 15 games of simulated NBA basketball based on a randomly generated schedule). Each participant selection is based on a pre-configured subset, where a subset contains one or more events (i.e. five NBA basketball players). The game operator manually selects or the server generates a selection based on a pre-configured subset of events in the basket to serve as a benchmark (i.e. a benchmark lineup of five NBA players is either manually selected by the operator or randomly generated). Participant selections are submitted, and the simulation engine randomly simulates results of the events in the basket based on their historical, statistical performance using objective criteria (the performance of all NBA players in the basket are simulated based on their historical, statistical performance, i.e. scoring, assists, rebounds, etc.). The server has a way to determine the results of the events from the basket and the performance of each participant submitted subset as well as the benchmark based on objective criteria (all participant lineups are scored as well as the benchmark lineup). The server has a way to determine the relative performance of the submitted subset of all participants (participant lineups are ranked against each other based on their relative performance). The server also has a way to determine the relative performance of the submitted subset of all participants with the benchmark. Prizes are awarded to participants whose selected subsets beat the benchmark (i.e. everyone who beats the benchmark wins or is eligible for a prize or payout) and/or produce the greatest relative performance (participants with the highest scoring lineups win a prize or payout).

In another embodiment, a gaming system is disclosed including a server having a basket comprising a set of events and a simulation engine. There are several participant devices connected to the server. The server determines and the participant devices display standard wagering metrics (i.e. a point spread, over-under, odds, parlay or payout) of certain potential outcomes of events in the basket or the combination of potential outcomes multiple events therein of the simulation. The participant devices accept participant selections and wager amount with respect to a pre-determined event or combination of events. Each participant selection is comprised of a specific traditional sportsbook, pari-mutuel or fixed payout wager based on the outcome of one or a combination of multiple events in the basket. Participant selections and wagers are submitted, and the simulation engine randomly simulates results of the events in the basket based on their historical, statistical performance using objective criteria. The server has a way for determining the success of the participant selections based upon the results of the simulation and a means for allocating payouts or prizes to participants using traditional sportsbook or pari-mutuel wagering methodology.

In another embodiment, a gaming system is disclosed including a server having a basket comprising a set of events (i.e. NBA basketball games) and a simulation engine. There are several participant devices connected to the server. The server determines and the participant devices display standard wagering metrics (i.e. the point spread, over-under and moneyline) for the events in the basket (i.e. the point spread for a given game such as the Indiana Pacers −4 pts vs. the Chicago Bulls +4 pts). The participant devices accept participant selection and wager amount (i.e. the participant selects the Indiana Pacers −4 pts for $110 to win $200). The participant selection and wager is submitted, and the simulation engine randomly simulates the results of the events in the basket based on their historical, statistical performance using objective criteria (i.e. the score of the Indiana Pacers vs. Chicago Bulls game is randomly simulated using the historical statistical performance data of each team). The server has a way for determining the success of the participant selections based upon the results of the simulation (i.e. the simulation produces scores for each team and the Indiana Pacers win 110 to 102. Since the Indiana Pacers won by a margin greater than four points, the participant's selection and wager are considered successful) and a means for allocating payouts or prizes to the participant (i.e. the participant is awarded $200 for his $110 bet).

In one embodiment of a tournament game format, a random schedule of underlying events (i.e. sporting events such as a schedule of games) is generated. Participants enter the game by submitting an initial wager or “ante” of real or virtual currency. Next, participants are either randomly assigned a plurality of athletes (a lineup) from a discrete set of athletes or are required to manually select a plurality of athletes from a discrete set of athletes. A method of simulation is then employed using the historical performance of the athletes in the discrete set coupled with other variables (such as an opposing team's quality of defense, location of the underlying sporting event, etc.). Once the simulation is completed, fantasy points for each athlete in the discrete set are calculated, including the athletes of each participant's lineup, which are accumulated to reveal a fantasy point total per lineup. The results from the simulation are then revealed simultaneously to all participants and the participants are then ranked with the highest-ranking participants earning a payout or a prize based on a pre-set schedule or formula.

Another embodiment of a tournament game format is a format that combines fantasy sports with the wagering mechanics of online poker where a limited number of participants play against each other at a single “table”. A random schedule of underlying events (i.e. sporting events such as a schedule of games) is generated. Participants then enter the game by submitting an initial wager or “ante” of real or virtual currency. Next, participants are either randomly assigned a plurality of athletes (a lineup) or are required to manually select a plurality of athletes from a discrete set. Athletes may or may not be mutually exclusive to a single participant. The method of simulation is then employed using the historical performance of the athletes in the discrete set coupled with other variables (such as an opposing team's quality of defense, location of the underlying sporting event, etc.). Once the simulation is completed, fantasy points for each athlete in the discrete set are calculated. The results from the method of simulation are then revealed in groupings. For example, the results of the first four of sixteen games from the random schedule are revealed along with the performance of the athletes in the discrete set from teams in the grouping. After the revelation of a grouping, poker-style wagering or “table” wagering mechanics are employed, and participants bet sequentially and may elect to fold, check, call, or raise. Once the round of table wagering is completed, the results from the next grouping are revealed and the process starts anew. After all groupings have been revealed and final table wagering has concluded, the lineups remaining participants (those who did not fold) are objectively measured and scored and then ranked with the highest-ranking participant winning the prize pool, or an amount based on a pre-set payout scheme.

Yet another embodiment of a Tournament game format is a game format that combines fantasy sports with staged wagering where the number of entrants is not limited. A random schedule of underlying events (i.e. sporting events or games) is generated. Participants enter a contest by submitting an initial wager or “ante” of real or virtual currency. Next, participants are either randomly assigned a plurality of athletes (a lineup) or are required to manually select a plurality of athletes from a discrete set of athletes. Athletes are not mutually exclusive to a single participant. The method of simulation is then employed using the historical performance of the athletes in the discrete set coupled with other variables (such as an opposing team's quality of defense, location of the underlying sporting event, etc.). Once the simulation is completed, fantasy points for each athlete in the discrete set are calculated. The results from the simulation are then revealed in groupings. For example, the results of the first four of sixteen games from the random schedule are revealed along with the performance of the athletes in the discrete set from those teams. After the revelation of a grouping, an opt-in wagering scheme is employed whereby participants may elect to stay in and submit an additional wager of real or virtual currency or fold and exit the game. Once all participants have made a declaration (or have folded by default due to the expiration of time), the results from the next grouping are revealed and the process starts anew. After all groupings have been revealed and the final round of staged wagering has concluded, the remaining participants' lineups are objectively measured and scored and then ranked with the highest-ranking participants earning a payout or a prize based on a pre-set schedule or formula.

One embodiment of a House Game is a game format that combines the characteristics of a slot machine with the game mechanics and skill of fantasy sports where a participant plays against the game operator as opposed to other participants. Using American football as an example, a random schedule is generated that matches football teams against each other. Next, a participant is required to select a plurality of athletes for a lineup from a discrete set of athletes. The method of simulation is then employed using the historical performance of the athletes in the discrete set resulting in an assignment of fantasy points for each athlete, including the athletes in the participant's lineup. Next, the participant's selections are objectively measured and scored, and the participant is rewarded based on a pre-set payout or prizing schedule.

Another embodiment of a House Game is a format where a participant is required to predict the top-ranking athletes out of a given set of athletes based on objective scoring criteria. For example, a participant might be required to predict the top five performing quarterbacks for one simulated week of the football season. The user would then select five quarterbacks from a discrete set of available quarterbacks. A simulation method would be employed utilizing the historical performance of the available set of quarterbacks to randomly generate the performance of each quarterback in the set. The quarterbacks in the set would then be ranked based on this performance and the final rankings would then be compared to the predicted rankings of the participant. The participant would then be rewarded according to a pre-set schedule based on the number of predicted quarterbacks that finished in the top five either in any order (i.e. Tom Brady was predicted to finish in the top three and finished 2nd, therefore a payout), or exact order (i.e. Tom Brady was predicted to finish 2nd and finished 2nd, therefore a payout).

In another embodiment of a House Game, the method of simulation would be combined with betting mechanics that mimic those commonly found in pari-mutuel wagering, such as win, place, show, quinella (to two any order), perfecta (top two perfect order), trifecta (top three perfect order), etc. However, unlike pari-mutuel wagering, payouts would be fixed in advance of the placement of the wager and would not fluctuate as additional wagers are entered either from the participant or other participants. For example, predict the top two performing quarterbacks for one week of the NFL season and win $5.00 for every $1.00 wagered in real or virtual currency.

In yet another example the method of simulation is combined with traditional sport book style wagering (i.e. bet to win, moneyline, point spread, handicap, over/under, parlays, etc.). For example, a participant might bet that the simulated results will reveal that Dallas beat Pittsburgh where a projected point spread is set at Dallas minus six points.

In an embodiment of a Pari-Mutuel game format, actual pari-mutuel wagering is employed based on the simulated results. Once the predictions or wagers have been placed by participants, the method of simulation would be employed, and the simulated results would be revealed with all participant picks being scored and then awarded if correct.

In another embodiment, a gaming system is disclosed including a server having a basket comprising a set of events and a simulation engine. There are several user devices connected to the server. The user devices accept user selections with respect to a pre-determined game. Each user selection is based on a pre-configured subset, where a subset contains one or more events and the outcome of the game is influenced by the skill and knowledge of the users. User selections are submitted, and the simulation engine simulates results of the events in the basket based on their historical performance using objective criteria. The server has a way to determine the results of the events from the basket and the performance of each user submitted subset based on objective criteria and the server has a way to determine the performance of the submitted subset of all users. Prizes are awarded to participants whose selected subsets produce the greatest relative performance.

In another embodiment, a gaming system is disclosed including a server having a basket comprising a plurality of events and a simulation engine. There are several user devices connected to the server. The user devices accept user selections with respect to a pre-determined game and each user selection includes a subset of the basket. User selections are submitted, and the simulation engine simulates results of the events in the basket based on their historical performance using objective criteria. In this, the outcome of the game is influenced by the skill and knowledge of the users. The gaming system has a way to score the results of the submitted user subsets, and to award prizes according to a pre-configured payout scheme based on the score earned by a user for a given submitted subset.

In another embodiment, a gaming system is disclosed including a server having a basket comprising a plurality of events and a simulation engine. There are several user devices connected to the server. The user devices accept user selections with respect to a pre-determined game and each user selection includes a subset of the basket. User selections are submitted, and the simulation engine simulates results of the events in the basket based on their historical performance using objective criteria. In this, the outcome of the game is influenced by the skill and knowledge of the users. The gaming system has a way to score the results of the submitted user subsets, and to award prizes according to a pari-mutuel payout scheme that adjusts payouts based on the number of user submissions or relevant or competing subsets.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates schematic view of a skill gaming system.

FIG. 2 illustrates a typical computer system.

FIG. 3 illustrates an exemplary user interface of the gaming system where the objective involves selection from baskets of players.

FIG. 3A illustrates an exemplary user interface of the gaming system of FIG. 3 showing results.

FIG. 4 illustrates a second exemplary user interface of the gaming system where the objective involves selection from baskets of players and staged wagering is employed.

FIG. 4A illustrates an exemplary user interface of the gaming system of FIG. 4 showing results.

FIG. 5 illustrates a third exemplary user interface of the gaming system where the objective involves selection from baskets of American football players and table wagering is employed.

FIG. 6 illustrates a fourth exemplary user interface of the gaming system where the objective involves selecting the top wide receivers for a given time period (e.g. week), in perfect order.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, examples of a game of skill are given relating to the embodiments described above.

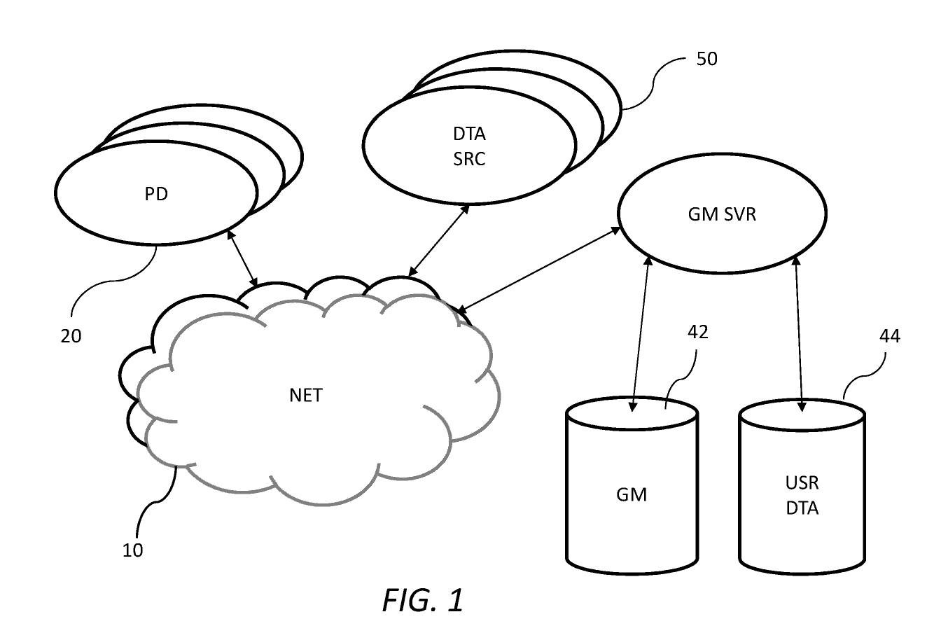

Referring to FIG. 1, a schematic view of a gaming system is shown. Multiple participant devices 20 (computers, smart phones, etc.) connect to the game server 40 through a network 10, for example, through the Internet.

Game details and settings are stored in a game storage area 42, such as, the list of games to be simulate, the list of players for selection by the participants, the starting date and time, the ending date and time, and the number of players that each participant must select.

The data sources 50 include any reputable source of outcomes such as newspapers (e.g., USA Today), sport-based services, financial services, race track web sites, etc. In some embodiments, the data is directly downloaded from the data sources 50, through a network 10 (e.g., the Internet), while in other embodiments, the data is manually entered into the game server 40 through a user interface.

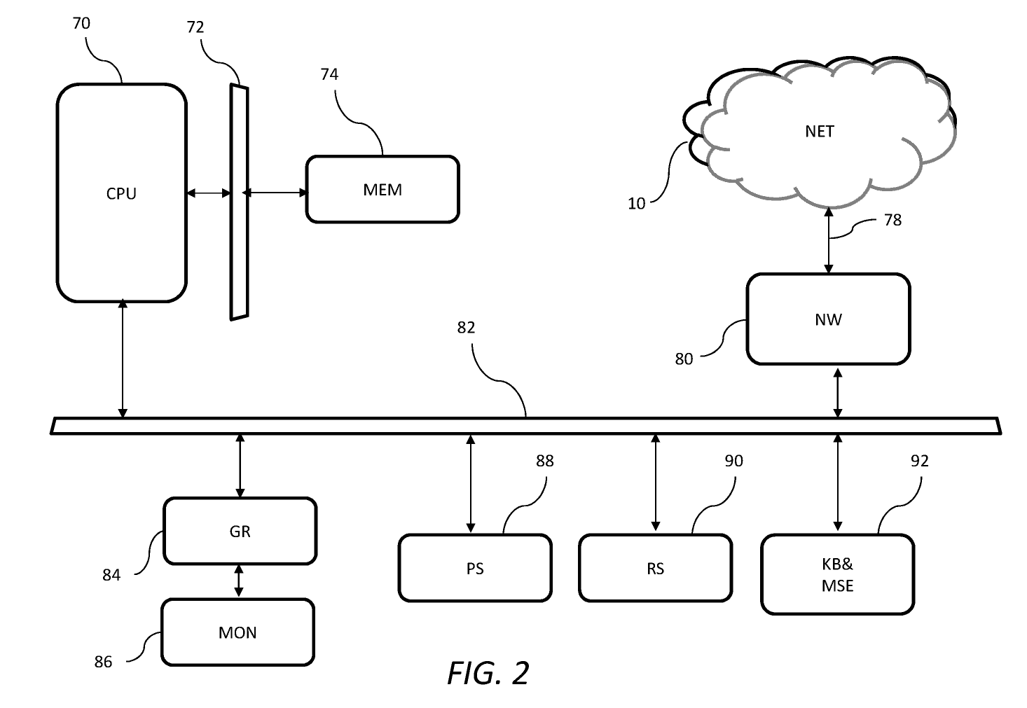

Referring to FIG. 2, a schematic view of a typical computer system is shown. The example computer system represents a typical computer system used as the game server 40 and/or the participant devices 20. The example computer system is shown in its simplest form, having a single processor. Many different computer architectures are known that accomplish similar results in a similar fashion and the present invention is not limited in any way to any particular computer system. The present invention works well utilizing a single processor system, as shown in FIG. 2, a multiple processor system where multiple processors share resources such as memory and storage, a multiple server system where several independent servers operate in parallel (perhaps having shared access to the data), or any combination, etc. In such systems, a processor 70 executes or runs stored programs that are generally stored for execution within a memory 74. The processor 70 is any processor or a group of processors, for example an Intel Pentium-4® CPU or the like. The memory 74 is connected to the processor, for example, by a memory bus 72 and is any memory 74 suitable for connection with the selected processor 70, such as SRAM, DRAM, SDRAM, RDRAM, DDR, DDR-2, etc. Also interfaced to the processor 70 is a system bus 82, for example, interfacing peripheral subsystems such as a network interface 80, persistent storage 88 (e.g. a hard disk), removable storage 90 (e.g. DVD, CD, flash drive), a graphics adapter 84 and a keyboard/mouse 92, etc., to the processor 70. The graphics adapter 84 receives commands and display information from the system bus 82 and generates a display image that is displayed on the display 86.

In general, the persistent storage 88 is used to store programs, executable code and data such as user financial data in a persistent manner. The removable storage 90 is used to load/store programs, executable code, images and data onto the persistent storage 88.

These peripherals are examples of persistent storage 88 and other examples of persistent storage 88 include FRAM, flash memory, etc. Other examples of removable storage 90 include CDRW, DVD, DVD writeable, Blu-ray, SD cards, other removable flash media, floppy disk, etc. In some embodiments, other devices are connected to the system through the system bus 82 or with other input-output connections/arrangements as known in the industry. Examples of these devices include printers; graphics tablets; joysticks; and communications adapters such as modems and Ethernet adapters.

The network interface 80 connects the computer-based system to the network 10 through a link 78 which is, preferably, a high speed link such as a cable broadband connection, a Digital Subscriber Loop (DSL) broadband connection, fiber optics, a T1 line, or a T3 line

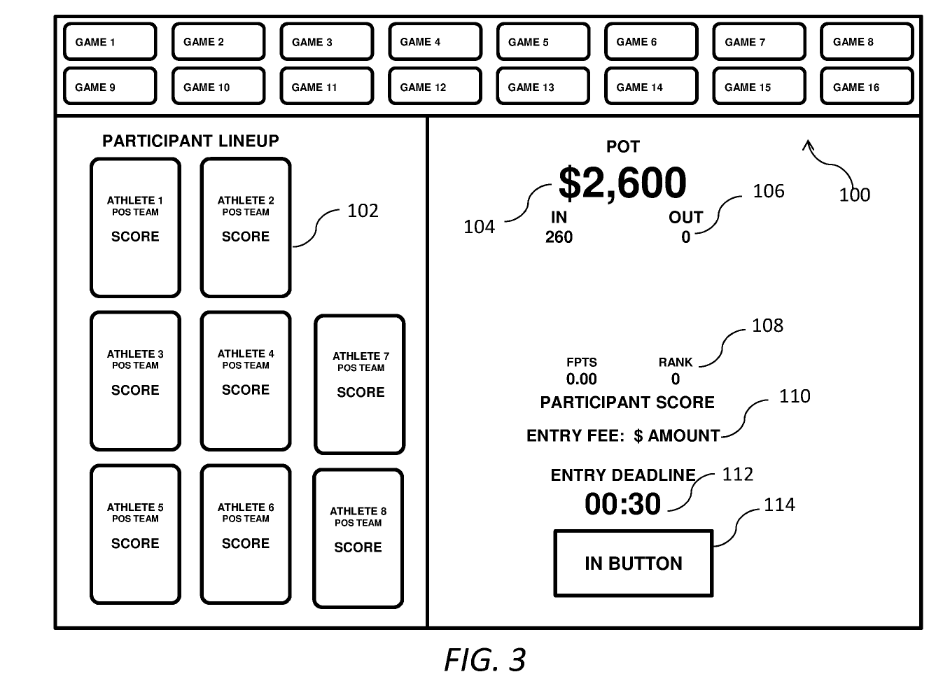

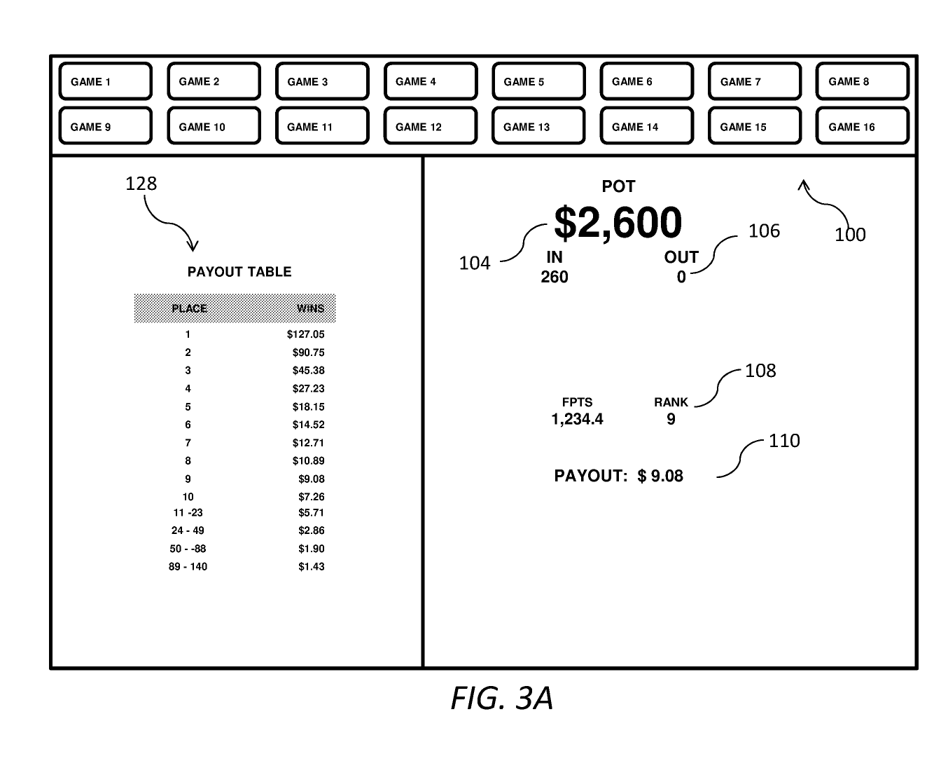

FIGS. 3 and 3A represent typical user-interfaces for a simulation game where the basket includes players (individual athletes) or teams related to a team sport (e.g. football, soccer, basketball, and hockey). A random schedule 100 of games or events is generated by the game server 40 (in this example shown as sixteen games such as sixteen football matches) and participants either select or are randomly assigned a sub-set of the players 102 (or teams) from the basket (in this example, the player has selected eight players) and then compete in a single round of wagering.

It is anticipated that the random schedule 100 of events (games), will influence the outcome of the simulation based on variables such as venue of a given game (e.g. home or away), quality of an opposing team's defense, etc. The sub-set of the players 102 has either been selected by the participants or is randomly assigned to participants before the game starts.

The cumulative amount wagered 104 indicates the total wagers made to a specific point of time by all participants (in this example, 260 players at $10 each is $2,600). The number of participants 106 indicates the number of participants who are currently participating (in) and the number of participants who are no longer participating (out). The participant's score and rank 108 will be generated after the simulation has been completed to apprise the participant of their achievement. A system messaging window 110 displays the amount required for an entry fee (e.g. $10), and then after the simulation has been completed and the relative rank of the participant has been determined, whether a prize our payout has been earned by the participant. The clock 112 counts down to the entry deadline. The “In” button 114 must be selected by the participant in order to enter a game or contest.

In a typical contest, the random schedule 100 of games, is generated by the game server 40 and transmitted to the participant devices 20 for display in the user interface. The participants then select or are assigned a sub-set from the basket of the players 102. Next, the participant must click the “In” button 114 and, hence, pay the required entry fee as indicated in the messaging window 110, at which time the participant's selections are transmitted to the game server 40 to record the participant's selections and entry into the game. Entries must be entered before the clock 112 reaches zero. Once the clock 112 reaches zero, the number of participants 106 and the cumulative amount wagered 104 are displayed in the user interface.

Now, the simulation is performed by the game server 40 and then the game server 40 determines participant scores, ranking the relative scores of the participants. The participant scores and rank are transmitted to the participant device 20 and displayed as in FIG. 3a including the participant's score and rank 108 (e.g. 1,234.4 fantasy points and a rank of 9^{th}). The game server 40 determines the prize or payout and transmits the payout table 128 to each participant device 20 for display in the user interface and provides the payout amount displayed in the messaging window 110. In this example, the participant had an overall rank of 9^{th} and earned a payout of $9.08.

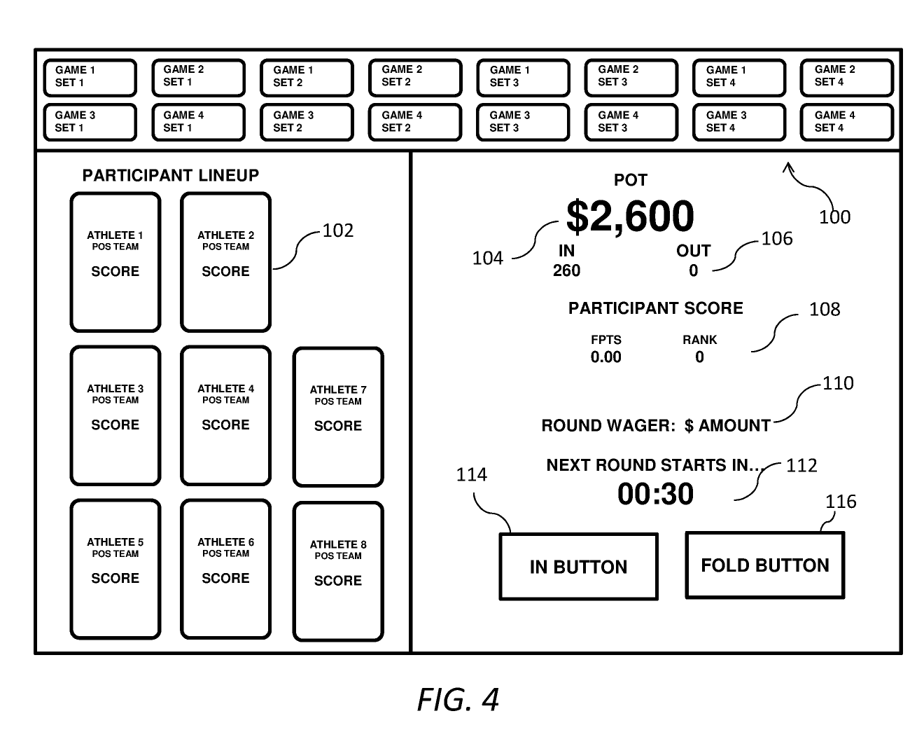

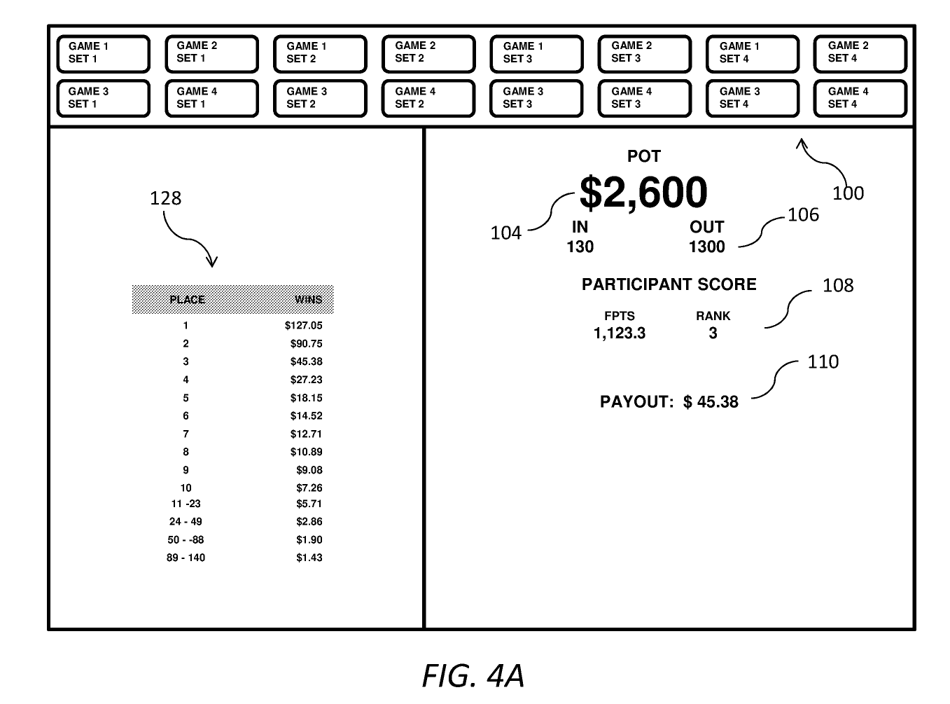

FIGS. 4 and 4A represent typical user-interfaces for a simulation game where the basket includes players (individual athletes) or teams related to a team sport (e.g. football, soccer, basketball, and hockey). In this, a random schedule 100 of games is generated and participants either select or are randomly assigned a sub-set from the basket and then staged wagering is employed in which, for example, a first set of events are simulated (e.g. those marked “set 1 in the random schedule 100 of games or events) then a round of betting is performed, then a second set of events are simulated (e.g. those marked “set 2 in the random schedule 100 of games) then another round of betting is performed, and so on.

Again, the random schedule 100 of games will influence the outcome of the simulation based on variables such as venue of a given game (e.g. home or away), quality of an opposing team's defense, etc.

In this example of the game, the random schedule 100 of games includes the teams that are assigned to play in each game, but also breaks down the games into sets (i.e. four sets of four games denoted “set1,” “set2,” “set3,” and “set4”). The plurality of players 102 reflects the players/teams from a basket of players/teams that have either been selected by each game's participants or randomly assigned to each game's participant before the game starts.

The cumulative amount wagered 104 indicates the total wagers made to a specific point of time by all participants (in this example, 260 players at $10 each is $2,600). The number of participants 106 indicates the number of participants who are currently participating (in) and the number of participants who are no longer participating (out). The participant's score and rank 108 will be generated and displayed after each round of the simulation has been completed to apprise the participant of their achievements so far. A system messaging window 110 displays the amount required for an entry fee (e.g. $10) and/or subsequent bets.

After each round of the simulation has been completed and the relative rank of the participant has been determined, whether a prize our payout has been earned by the participant. The clock 112 counts down to the entry deadline (or the betting deadline in subsequent rounds of betting). The “In” button 114 must be selected by the participant in order to enter a game or contest and to make their bet. Alternately, if the participant does not wish to continue in the game/contest, the participant selects the fold button 116 and forfeits any potential winnings.

In a typical contest, the random schedule 100 of games or events, is generated by the game server 40 and transmitted to the participant devices 20 for display in the user interface. The participants then select or are assigned a sub-set from the basket of the players 102. Next, the participant must click the “In” button 114 and, hence, pay the required entry fee as indicated in the messaging window 110, at which time the participant's selections are transmitted to the game server 40 to record the participant's selections and entry into the game. Entries must be entered before the clock 112 reaches zero. Once the deadline has expired and the number of participants 106 and the cumulative amount wagered 104 are displayed in the user interface.

In each round, the results of the simulation are revealed by set (e.g. set1, set2, set3, set4, etc.). The results are transmitted from the game server 40 to each participant device 20 and displayed in the user interface showing each of the participant's scores and ranks 108. The final game score for all of the games of a given set and the simulated performance of any athlete who played in any of the simulated games in that set are displayed. For example, in football, if the first game of set 1 includes the Team-01, then all players in the plurality of events who play for Team-01 would also be revealed. Next, a round of betting is performed and the participant must either click the “In” button 114 and pay the required wager for that round to stay in, or click the fold button 116 and exit the game or contest before the clock 112 reaches zero. Once the clock 112 reaches zero, the updated number of participants 106 and the cumulative amount wagered 104 are displayed in the user interface. The process then repeats for the next set of games until all of the sets of games have been played. Now, the game server 40 calculates final participant scores and ranked as well as the prize or payout to be awarded to each participant. The game server 40 sends the final participant scores, ranks and payouts to each participant device 20 and each participant device 20 displays a user interface that includes the payout table 128 and the participant's score and rank 108 as shown in FIG. 4A.

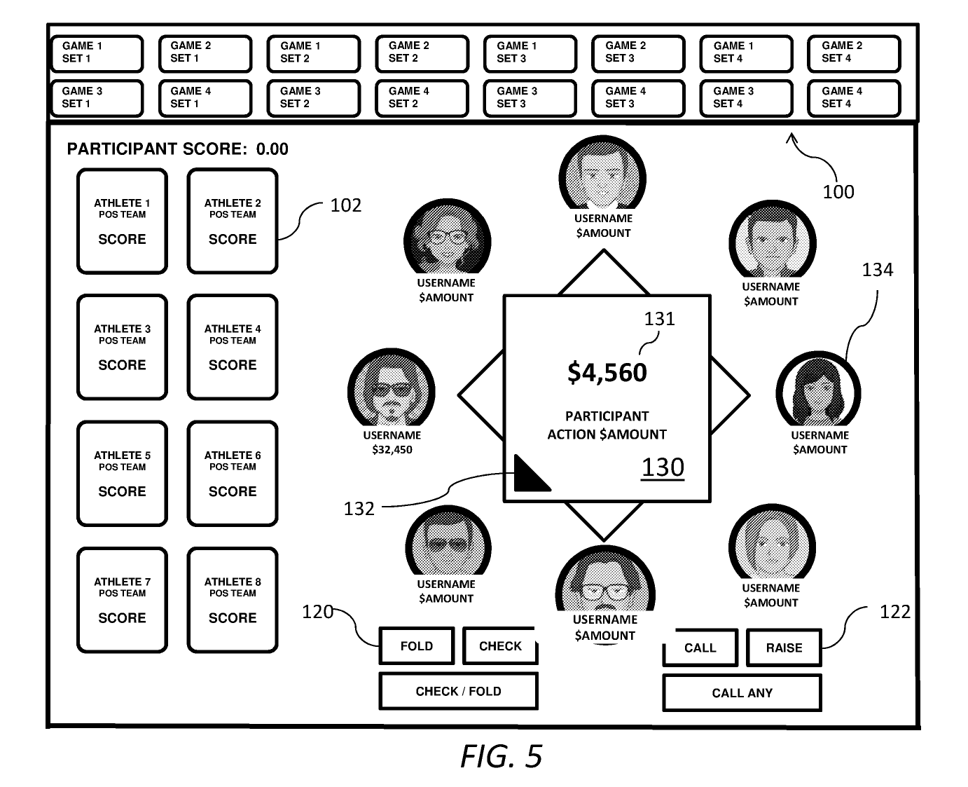

FIG. 5 represents a typical user-interface for a simulation game where participants either select or are randomly assigned a sub-set of players 102 (shown as players in this example) based upon a random schedule 100 that is generated by the game server 40. After participants either select or are randomly assigned this sub-set of players 102, table wagering is employed (e.g., betting, raising, calling, or folding).

The random schedule 100 of games or events will influence the outcome of the simulation based on variables such as venue of a given game (e.g. home or away), quality of an opposing team's defense, etc.

The schedule includes the teams that are assigned to play in each game organized into sets (i.e. four sets of four games each). The cumulative amount wagered 131 includes all bets and antes collected up until a specific point in time from all participants. A flag 132 indicates which player at the table 130 is currently in sequence for making the next bet (betting, raising, calling, folding) in the table betting. In some embodiments, avatars 134 of each participant in the game are provided.

In a typical contest, the random schedule 100 is generated by the game server 40 and transmitted to each participant device 20. Each participant device 20 presents the user interface and provides for mechanisms for each participant to select a sub-set of teams/players or be assigned a sub-set of teams/players from a basket. The sub-set of the players 102 is displayed in the user interface by the participant device. Next, each participant enters the game and pays an initial entry fee, if required.

After all participants have made their selections and agreed to the initial entry fee, the results of the simulation are revealed by set (not that the random schedule 100 is organized into four sets, “set1,” “set2,” “set3,” and “set4”) in the same manner as FIGS. 4 and 4A. Next, table wagering is employed sequentially with the current participant in sequence being indicated by a flag 132. When a participant is in sequence, they utilize betting buttons 120/122 to indicate their wager. Once a participant has made their bet, their betting decision is transmitted to the game server 40 and the cumulative amount wagered 131 is updated and displayed on the user interface for all participants and the flag 132 shifts (e.g. clockwise) to request betting by the next participant. Once all table wagering has concluded for the given round of wagering, the results of the current set of games (e.g. “set1,” “set2,” “set3,” and “set4”) are transmitted from the game server 40 to each participant device 20 where it is displayed in the user interface. The game server 40 determines the participant scores and the relative rank of the participants. These participant scores and the relative rank of the participants are sent to the participant device 20 and displayed in the user interface. In some embodiments, the participant's scores are revealed only to the participant, but not revealed to the other participants, though in some embodiments, the participant's scores are revealed to other participants. The above process repeats with another round of wagering then revealing the outcome of the next set or games until all of the sets of games have been revealed and table wagering has concluded.

Next, final participant scores are ranked by the game server 40 and revealed to the participants. The game server 40 then determines the prize or payout to be awarded to each player and the game server 40 sends the award to the participant devices 20 for display in the user interface for the participants to see.

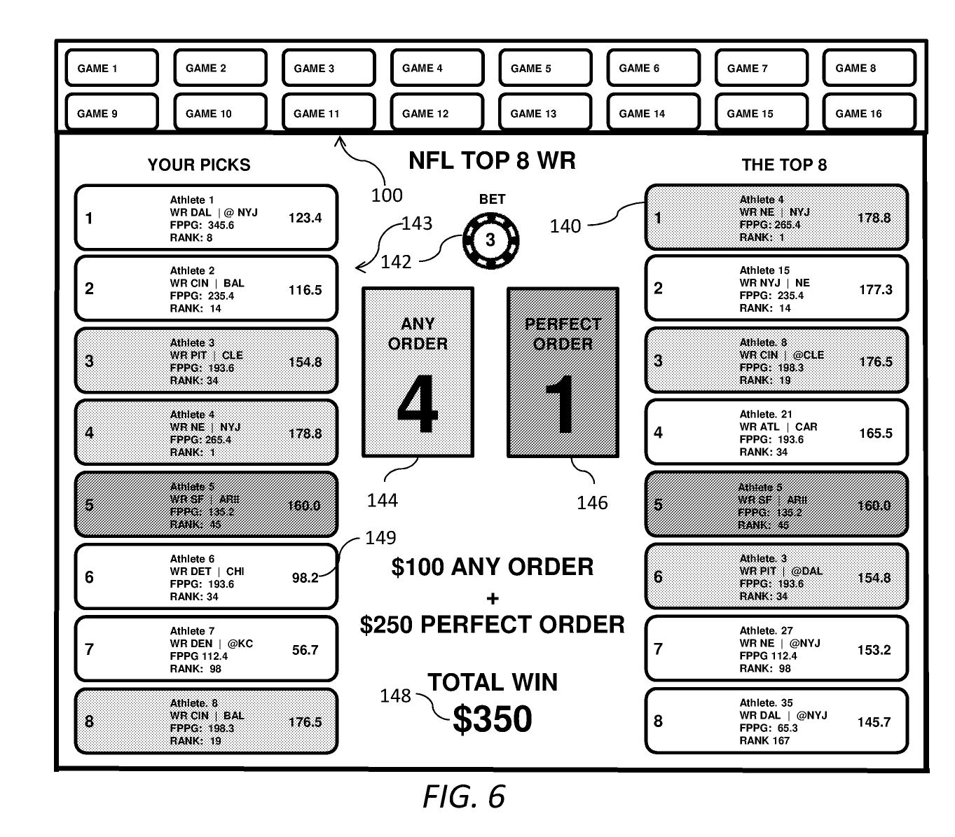

FIG. 6 represents a typical user-interface for a simulation game where a single participant either selects or is randomly assigned a sub-set 143 of the players/athletes and then competes against the game operator in a single round of wagering. The basket of players/athletes represents individual athletes in a team sport where a random schedule 100 is generated. This random schedule 100 of games will influence the outcome of the simulation based on variables such as venue of a given game (e.g. home or away), quality of an opposing team's defense, etc.

In some embodiments, the sub-set 143 is selected by the participant while in other embodiments, the sub-set 143 is randomly assigned to the participant before the game starts. The amount wagered 142 by the participant is displayed, e.g., in terms of chips, dollars or any other acceptable measurement.

In a typical contest, the random schedule 100 is generated by the game server 40 and transmitted to the participant device 20 where it is displayed in the user interface. Next, the participant will select or be assigned a sub-set 143 from the basket of players/athletes. Next, the participant must set the amount to be wagered, as indicated by the amount wagered 142 and then click an enter button.

After the participant selects the enter button, the participant's selections and wager is sent to the game server 40 and the participant's selections and wager is saved. The simulation is then performed by the game server 40, determining winners and fantasy points 149 for each player/athlete. This simulation includes the simulation of all games in the random schedule 100 to determine the performance of all players/athletes, including the performance of the sub-set 143 of the participant. The relative performance or ranking of all players/athletes is generated and sorted into an ordered list 140 (e.g. the player/athlete with the highest number of fantasy points at the top). The game server 40 then calculates a score of the participant and whether the minimum threshold has been met for the participant to be awarded a prize.

In the example shown in FIG. 6, the scoring is based on the participant's prediction of the top eight performing wide receivers for one week of simulated football. In this example, the participant is scored based on the number of wide receivers correctly picked to be in the top eight in any order 144 and in perfect order 146. The game server then calculates the prize or payout to be awarded to each participant and sends the scoring and payout to the participant device 20 where the scores for order 144, perfect order 146, and the prize 148 are displayed in the user interface.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A gaming system comprising:
a server;
a plurality of participant devices;
the server generates a random schedule of games;
the server requests a first wager from each participant device;
each participant device makes a selection of a subset of players/teams that are associated with each game of the schedule of games;
the server simulates an outcome of the random schedule of games; and
each selection of the subset of players/teams is evaluated by the server to generate a score and a payout is made.

2. The gaming system of claim 1, wherein the payout is made to a single participant.

3. The gaming system of claim 1, wherein the payout is made to one or more participants having a top percentage of the scores.

4. The gaming system of claim 1, wherein the payout is made to a top number of participants having a highest score based upon a payout schedule.

5. The gaming system of claim 1, wherein the random schedule of games is sub divided into two or more sets of games and the server sequentially simulates an outcome of each of the sets of games.

6. The gaming system of claim 5, wherein a round of betting is performed after the server sequentially simulates the outcome of each of the sets of games.

7. A method of gaming by a set of participants, the method comprising:
generating a random schedule of games;
requesting a first wager from each participant;
receiving a subset of players/teams from each participant, the subset of players/teams comprising players/teams that will play in the games of the random schedule of games;
simulating an outcome of each game of the random schedule of games;
generating a fantasy score for each players/teams of the players/teams based upon the outcome of each game;
sorting each player by the fantasy score of the each players/teams; and
generating a score for each participant based upon the subset of players/teams from that participant and the fantasy score of each players/teams in the subset of players/teams from that participant.

8. The method of claim 7, further comprising awarding a payout to one or more participants based upon the score of each participant.

9. The method of claim 8, wherein the step of awarding the payout for the each participant based upon the subset of players/teams from that participant and the fantasy score of the each player in the subset of players/teams from that participant comprises awarding the payout for each player in the subset of players/teams from that participant having the top N fantasy scores in any order.

10. The method of claim 8, wherein the step of generating the score for the each participant based upon the subset of players/teams from that participant and the fantasy score of the each players/teams in the subset of players/teams from that participant comprises payments for each players/teams in the subset of players/teams from that participant having the top N fantasy score in a correct order.

11. The method of claim 7, wherein the step of simulating the outcome of each game of the random schedule of games is performed in stages with each stage comprising simulating the outcome of a subset of the random schedule of games.

12. The method of claim 11, wherein each stage comprises betting.

13. Program instructions tangibly embodied in a non-transitory storage medium comprising at least one instruction configured to implement a system for gaming between a set of participants, wherein the at least one instruction comprises:
computer readable instructions executed by a processor causing the system for gaming to generate a random schedule of games, each game having players;
the computer readable instructions executed by the processor causing the system for gaming to request a first wager from each participant of the set of participants;
for each participant in the set of in participants, the computer readable instructions executed by the processor causing the system for gaming to receive a subset of the players;
the computer readable instructions executed by the processor causing the system for gaming to simulate an outcome of each game of the random schedule of games;
the computer readable instructions executed by the processor causing the system for gaming to generate a fantasy score for each of the players based upon the outcome of each game;
the computer readable instructions executed by the processor causing the system for gaming to sort the players by the fantasy score of each player; and
the computer readable instructions executed by the processor causing the system for gaming to generate a score for each participant based upon the subset of players from that participant and the fantasy score of each player in the subset of players from that participant.

14. The program instructions tangibly embodied in a non-transitory storage medium comprising at least one instruction configured to implement a system for gaming between a set of players of game 13, wherein the at least one instruction further comprises computer readable instructions executed by the processor causing the system for gaming to award a payout to one or more participants based upon the score for the each participant.

15. The program instructions tangibly embodied in a non-transitory storage medium comprising at least one instruction configured to implement a system for gaming between a set of players of game 14, wherein the at least one instruction further comprises computer readable instructions executed by the processor causing the system for gaming to award the payout for the each participant based upon the subset of players from that participant and the fantasy score of the each player in the subset of players from that participant comprises awarding the payout for each player in the subset of players from that participant having the top N fantasy scores in any order.

16. The program instructions tangibly embodied in a non-transitory storage medium comprising at least one instruction configured to implement a system for gaming between a set of players of game 14, wherein the at least one instruction further comprises computer readable instructions executed by the processor causing the system for gaming to award the payout for the each participant based upon the subset of players from that participant and the fantasy score of the each player in the subset of players from that participant comprises awarding the payout for each player in the subset of players from that participant having the top N fantasy score in a correct order.

17. The program instructions tangibly embodied in a non-transitory storage medium comprising at least one instruction configured to implement a system for gaming between a set of players of game 13, wherein the at least one instruction that comprises computer readable instructions executed by the processor causing the system for gaming to simulate an outcome of each game of the random schedule of games further comprises computer readable instructions executed by the processor causing the system for gaming to reveal the outcome in stages with each stage comprising the outcome of a subset of the random schedule of games.

18. The program instructions tangibly embodied in a non-transitory storage medium comprising at least one instruction configured to implement a system for gaming between a set of players of game 17, wherein the at least one instruction that comprises computer readable instructions executed by the processor causing the system for gaming to reveal the outcome in stages with each stage comprising the outcome of a subset of a subset of the random schedule of games further comprises computer readable instructions executed by the processor causing the system for gaming to collect bets at each stage.

19. The program instructions tangibly embodied in a non-transitory storage medium comprising at least one instruction configured to implement a system for gaming between a set of players of game 13, wherein the at least one instruction that comprises the computer readable instructions executed by the processor causing the system for gaming to receive the subset of the players further comprises computer readable instructions executed by the processor causing the system for gaming to receive the subset of the players by inputs from a user interface.

20. The program instructions tangibly embodied in a non-transitory storage medium comprising at least one instruction configured to implement a system for gaming between a set of players of game 13, wherein the at least one instruction that comprises computer readable instructions executed by the processor causing the system for gaming to receive the subset of the players further comprises computer readable instructions executed by the processor causing the system for gaming to randomly generate the subset of the players.
